(19) United States
(12) Patent Application Publication
(10) Pub. No.: US 2026/0044689 A1
(43) Pub. Date: Feb. 12, 2026

(54) METHOD AND SYSTEM FOR TRANSLATING CONTENT

(71) Applicant: NAVER WEBTOON LTD., Seongnam-si (KR)

(72) Inventors: Jae Han YOON, Seongnam-si (KR); Yu Jin HONG, Seongnam-si (KR); Ji Seon SIM, Seongnam-si (KR); Jun Eyoun MOON, Seongnam-si (KR); Jae Hyuk JANG, Seongnam-si (KR); Wan Been JOO, Seongnam-si (KR); Joo A. CHA, Seongnam-si (KR); Ju Yul PARK, Seongnam-si (KR); Yu Jin CHUNG, Seongnam-si (KR); Young Sub CHOI, Seongnam-si (KR)

(21) Appl. No.: 18/982,746

(22) Filed: Dec. 16, 2024

(30) Foreign Application Priority Data
Aug. 6, 2024 (KR) 10-2024-0104874

(51) Int. Cl. G06F 40/58; G06V 30/18

(52) U.S. Cl. CPC G06F 40/58; G06V 30/18

(57) ABSTRACT

A method of translating content may include receiving an image file of a translation target in relation to an episode of content created based on a language of a first country, extracting a text corresponding to the language of the first country from the image file, and providing a translation editor for the image file so that a translated episode of the episode is generated based on a language of a second country different from the first country using the image file. The image file of the translation target is output in a first area of the translation editor, and an input window for inputting a translated language of the language of the second country for the extracted text is activated in a second area of the translation editor. The translated episode is generated using the translated language received through the input window.

### CROSS REFERENCE TO RELATED APPLICATION

The present application claims the priority of Korean Patent Application No. 10-2024-0104874, filed on Aug. 6, 2024, the entire contents of which are incorporated herein for all purposes by this reference.

### BACKGROUND OF THE INVENTION

### Field of the Invention

The present invention relates to a method of translating content and a system for supporting the same.

### Description of the Related Art

As technology advances, the use of digital devices increases. In particular, electronic devices (e.g., smartphone, tablet PC, etc.) is equipped with various functions including communication functions such as phone calls or text messages, as well as surfing the web, listening to music, and watching videos using the Internet.

With the popularization of the electronic devices, consumption of contents provided through the electronic devices such as PCs or mobile devices is rapidly increasing. As an example, there is webcomics. The webcomic is a comic serialized and distributed through an Internet communication network.

As the consumption of these webcomics continues to increase, various service providers (or webcomic-related service providers) are developing various services to secure users (or consumers, subscribers) who can use the services steadily.

For example, Korean Laid-Open Patent No. 10-2018-0119005 (a webtoon providing method using a sharing function) discloses a method of allowing a user owning a webcomic online to share the webcomic with other users. Those other users can read part of the webcomic and decide whether to make a purchase, thereby enabling users to purchase webcomics containing content of their preference.

Such webcomics go beyond being created by authors and provided as a service in their respective countries, and are now being serviced globally. Therefore, it is essential that they are translated into various languages of different countries. As described above, in order to enhance consumer purchase intent for content on a global scale, customized translation for each country is necessary. However, a systematic translation process for webcomics has not yet been established.

### SUMMARY OF THE INVENTION

The present invention relates to a method and a system for performing content translation, thereby enabling users from a plurality of countries to continuously use the content.

More specifically, the present invention is directed to a method of translating content that is capable of providing a user environment optimized for translation task, and a system for supporting the same.

Further, the present invention relates to a method that is capable of more systematically managing the translation task.

In order to solve the challenges discussed above, there is provided a method of translating content according one embodiment of the present invention. The method may include: receiving an image file of a translation target in relation to an episode of content created based on a language of a first country, extracting a text corresponding to the language of the first country from the image file, and providing a translation editor for the image file so that a translated episode of the episode is generated based on a language of a second country different from the first country using the image file, in which the image file of the translation target is output in a first area of the translation editor, and an input window for inputting a translated language of the language of the second country for the extracted text is activated in a second area of the translation editor, and the translated episode is generated using the translated language received through the input window.

There is provided a system for translating content according to the present invention. The system may include a management server for registering an image file of a translation target for an episode of content created based on the language of a first country, and a translation server for receiving the image file of the translation target, in which the translation server extracts a text corresponding to the language of the first country from the image file of the translation target, and provides a translation editor for the image file so that a translated episode of the episode is generated using the extracted text, and the image file of the translation target is output in a first area of the translation editor, and an input window for inputting a translated language of the language of the second country for the extracted text is activated in a second area of the translation editor, and the translated episode is generated using the translated language received through the input window.

There is a program executed by one or more processes in an electronic device and stored in a non-transitory computer-readable recording medium, according to the present invention. The program may include instructions to allow the electronic device to perform: receiving an image file of a translation target in relation to an episode of content created based on a language of a first country, extracting a text corresponding to the language of the first country from the image file, and providing a translation editor for the image file so that a translated episode of the episode is generated based on the language of a second country different from the first country using the image file, in which the image file of the translation target is output in a first area of the translation editor, and an input window for inputting a translated language of the language of the second country for the extracted text is activated in a second area of the translation editor, and the translated episode is generated using the translated language received through the input window.

The method and the system for performing content translation according to the present invention provide a new type of translation editor and review editor, thereby implementing a translation environment in which a translator and a reviewer can perform translation more accurately and efficiently.

Further, the method and the system for translating content according to the present invention may receive an image file of a translation target in relation to an episode of content created based on the language of a first country, extract a text corresponding to the language of the first country from the image file, and provide a translation editor for the image file so that a translated episode of the episode is generated based on the language of a second country different from the first country using the image file. Therefore, a translation representative may proceed with the translation task using one translation editor without having to use multiple programs alternately. Therefore, the present invention can improve the efficiency, convenience, and accuracy of the translation task.

Further, in the method and system for translating content according to the present invention, the image file of the translation target is output in a first area of the translation editor, and an input window for inputting a translated language of the language of the second country for the extracted text is activated in a second area of the translation editor, and the translated episode is generated using the translated language received through the input window. The representative can intuitively proceed with the translation task on the translation target image and can identify the immediate results of the translation task.

In addition, in the present invention, the translation support tool can be configured together with the image file of the translation target and the input window for the translated language on a single screen to support the translator's accurate translation. In this case, the image file is converted into a low-capacity file to implement more efficient data processing.

### BRIEF DESCRIPTION OF THE DRAWINGS

FIG. 1 is a diagram for describing a system for performing content translation according to the present invention.

FIGS. 2A and 2B are flowcharts for describing a method of performing content translation according to the present invention.

FIGS. 3A and 3B are flowcharts for describing data flow according to the method of performing content translation of the present invention.

FIGS. 4A-4D are diagrams for describing an operator account and a manager account according to the present invention.

FIG. 5 is a flowchart for describing a method of translating content in the system for performing content translation according to the present invention.

FIG. 6 and FIGS. 7A-7E are diagrams for explaining a translation editor provided in the present invention.

FIG. 8 and FIG. 9 are diagrams for explaining a review editor provided in the present invention.

### DETAILED DESCRIPTION OF THE INVENTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The terms “module”, “unit”, “part”, and “portion” used to describe constituent elements in the following description are used together or interchangeably in order to facilitate the description, but the terms themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be understood that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

The present invention relates to a method of performing content translation and a system therefor, which may provide a function interface necessary for translation, lettering, and review tasks of content, in linkage with content provision services, as well as a communication tool (e.g., Inbox, Message) between task operators.

The types of content to which the present invention may be applied may be highly diverse. For example, at least one type of content, such as webcomics, web novels, music, e-books, videos, or images, may correspond to the content provided in the present invention.

Hereinafter, for convenience of description, the content corresponding to a webcomic will be used as an example. Here, a webcomic refers to a combination of “web” and “comics,” meaning cartoons or comics provided through an Internet communication network.

Such content may be composed of a plurality of sub-content. A plurality of sub-content may make up a series of the content.

Here, a series may refer to sequentially planned works or content.

In the present specification, to avoid confusion between “content” and “sub-content,” the term “sub-content” will be referred to as “episode.”

In the present specification, “using (consuming or viewing) content” may be understood as using (consuming or viewing) an episode.

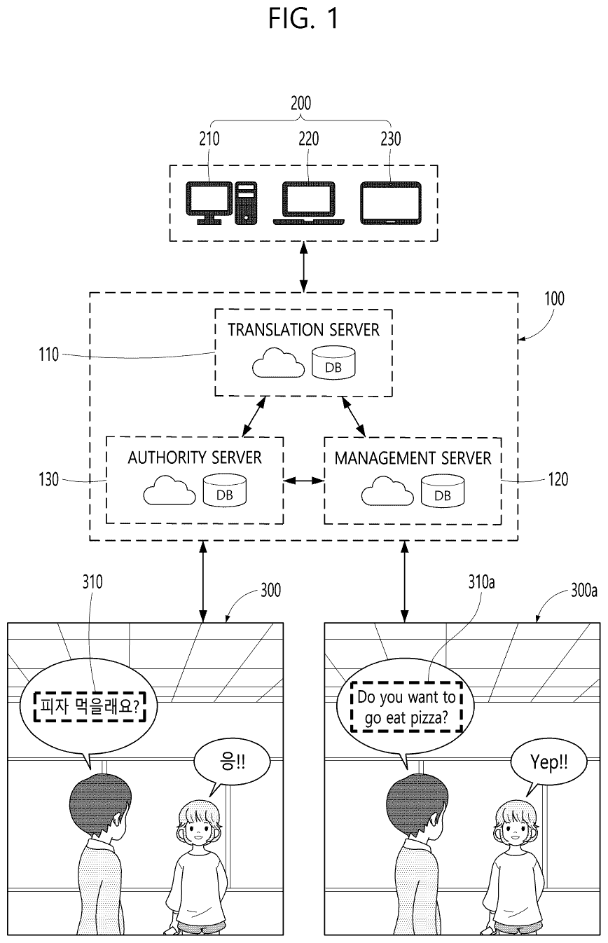

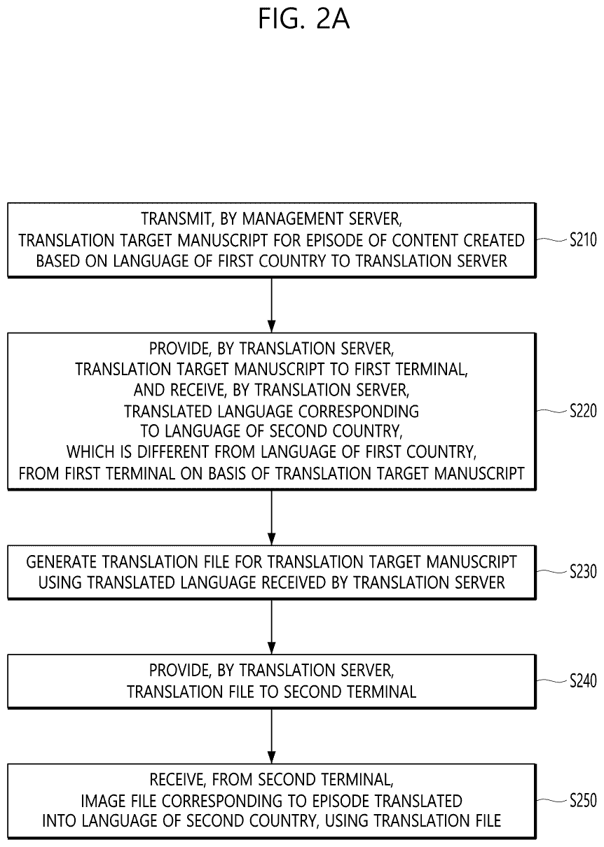

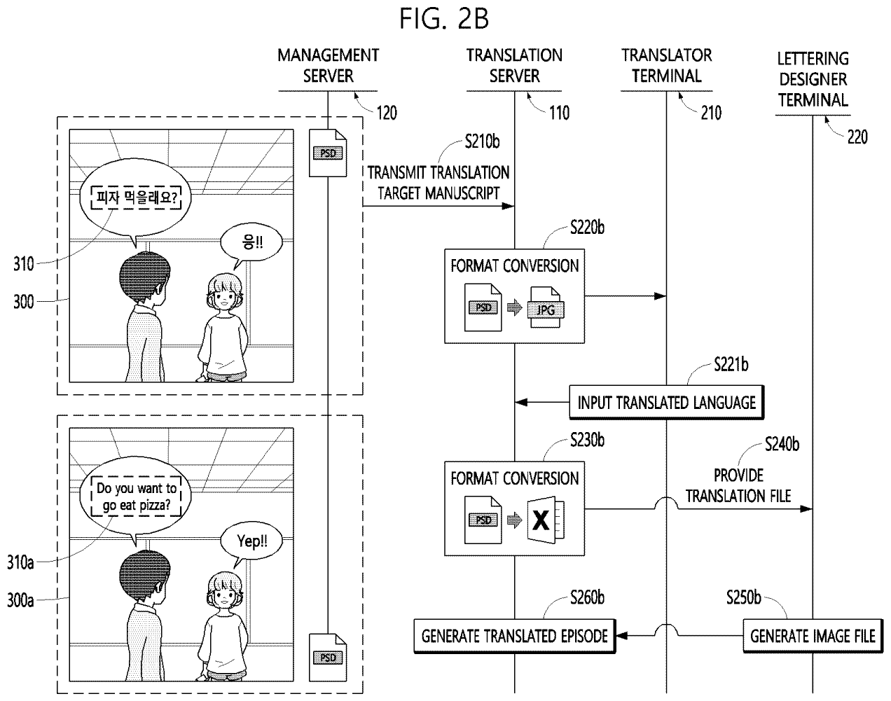

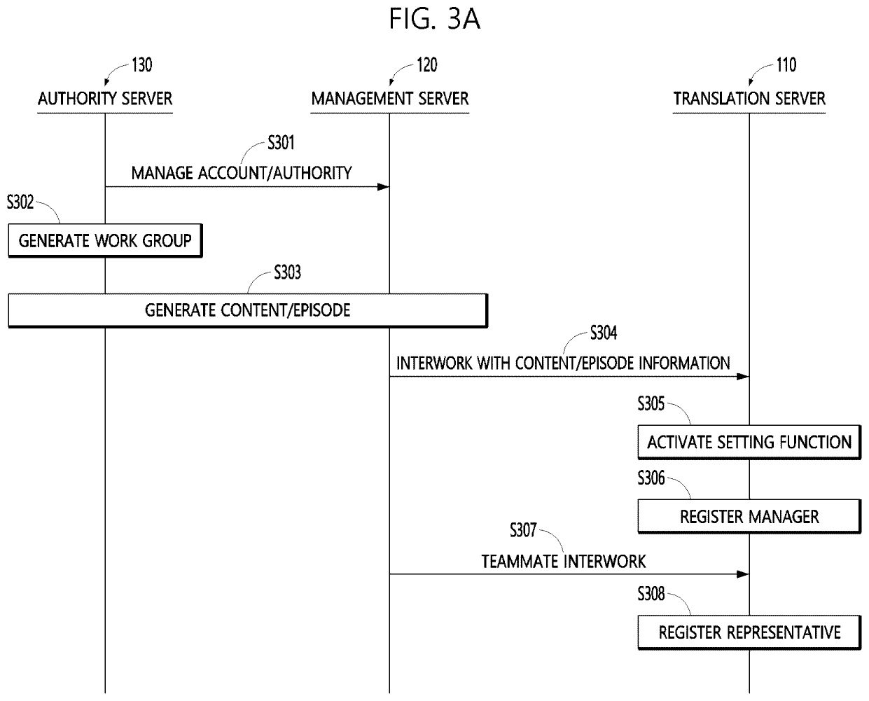

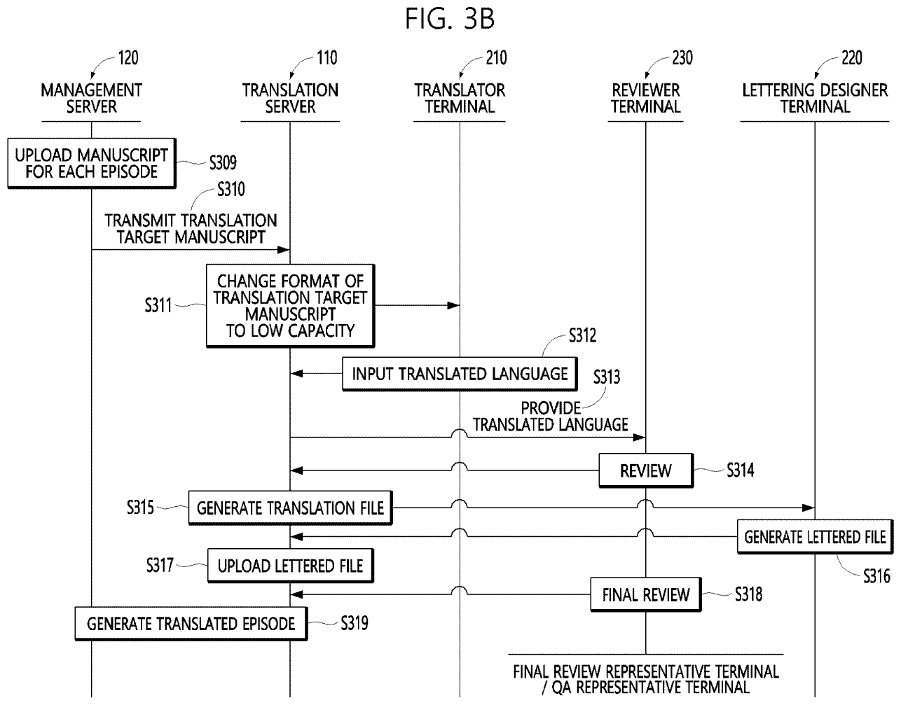

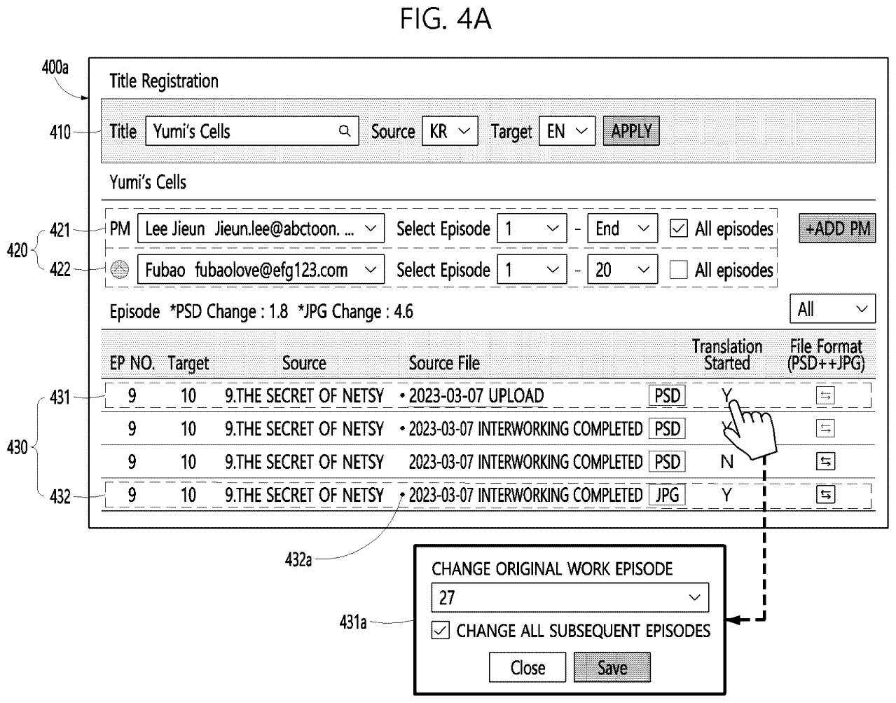

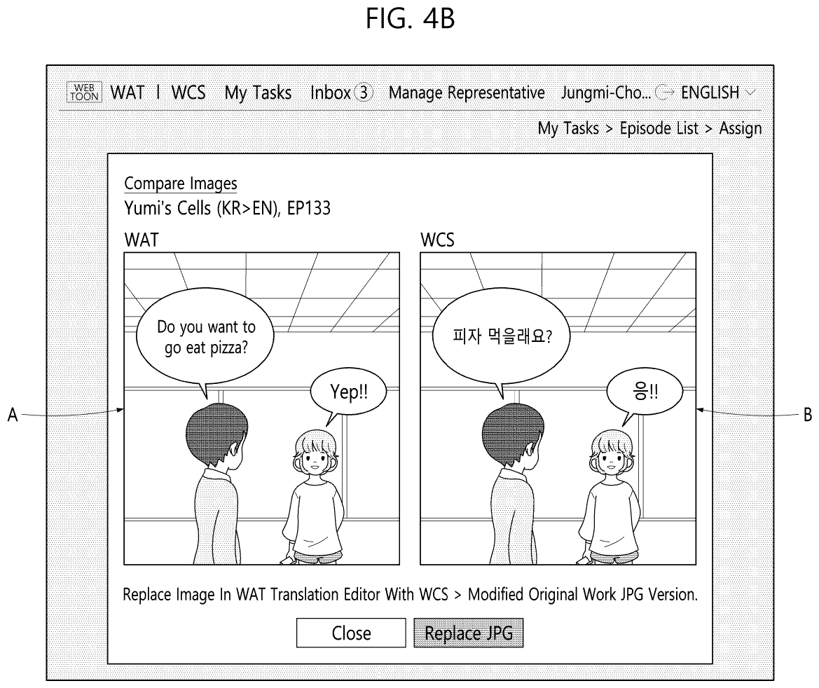

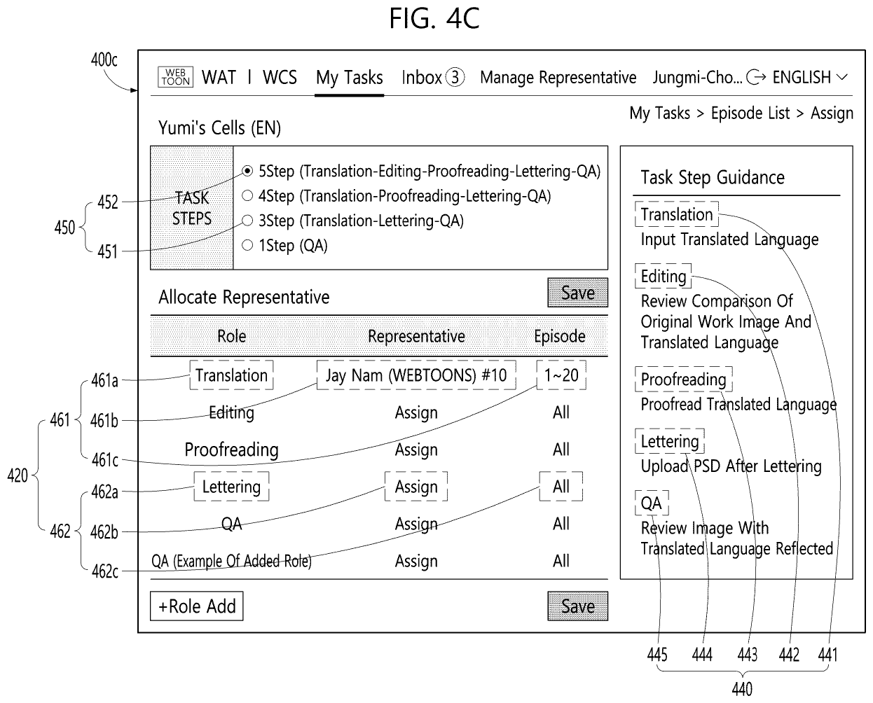

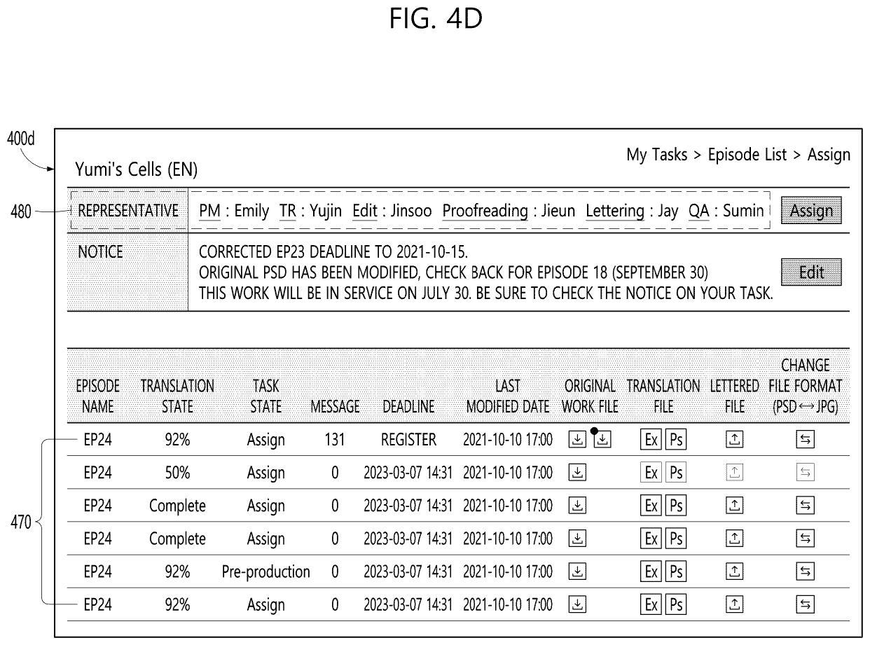

Hereinafter, a method of translating content will be specifically described with reference to the accompanying drawings. FIG. 1 is a diagram for describing a system for performing content translation according to the present invention. FIGS. 2A and 2B are flowcharts for describing a method of performing content translation according to the present invention, FIGS. 3A and 3B are flowcharts for describing data flow according to the method of performing content translation of the present invention, and FIGS. 4A-4D are diagrams for describing an operator account and a manager account according to the present invention.

As illustrated in FIG. 1, a system 100 for performing content translation may translate an episode 300 of content, which has been created based on the language of a first country (e.g., Korean, “ [symbol] ?”, 310), into the language of a second country that is different from the first country (e.g., English, “Do you want to go eat pizza?”, 310a).

Here, the “language of a first country” refers to a translation target language (original work language or source language), and the “language of a second country” may refer to the language of another country into which the language of the first country is translated (or target language).

The system 100 for performing content translation includes a task of translating the language of a first country (e.g., Korean, 310) included in a content episode into the language of a second country (e.g., English, 310a), as well as tasks of reviewing and lettering the translated language. In the present invention, this will be referred to as a “translation process” or a “translation review process.” However, this is merely an example for translation purposes, and the language of the second country may be any one of various languages, such as Japanese, Chinese, Spanish, Arabic, Indonesian, Thai, and others. Further, while the present invention provides an example of translating Korean into another language, it is also possible to translate another language into Korean or to translate between languages of different countries.

To provide such a translation process, the system 100 may include at least one of an authority server 130, a management server 120, and a translation server 110. The authority server 130, management server 120, and translation server 110 may be configured to transmit and receive various information related to content provision or content translation operations through wired or wireless communication. The transmission and reception of information may be performed by a communication unit included in each server 110, 120, or 130.

Here, each of the authority server 130, the management server 120, and the translation server 110 may be a computer system having at least one processor for performing various functions including providing information or services through a network. The servers 110, 120, 130 may be configured to exchange various information or data with other servers or user terminals. The authority server 130 may be configured to perform a role of managing authority for at least one of user accounts or content registered in the management server 120. The authority server 130 may receive a request for assigning authority or may assign authority on the basis of a specific condition being satisfied by a user account registered in the management server 120.

For example, the authority server 130 may assign an operator account, which holds the authority to operate the translation process, to a specific user on the basis of an operator account assignment request. As another example, the authority server 130 may register a specific user account, which is registered in the management server 120, as a manager who holds the authority to designate a representative for the translation process (e.g., translator, lettering designer, reviewer, etc.), on the basis of a request from an operator account.

The management server 120 may be configured to perform roles related to content provision and the management of content translation operations. The management server 120 may store original content (or original work content) received from an author, and on the basis of the original content, the management server 120 may provide the original content to the translation server 110 to carry out the translation process. In this case, the management server 120 manages user accounts and authority related to translation and performs the function of providing a source file of a translation target, as original content, to the translation server 110.

The system 100 may transform the file format of content episodes in various ways in the translation process and provide them to representatives.

For example, when an original episode image file received from the author is a high-capacity first type of file, the high-capacity file may be converted into a low-capacity second type of file and provided to the translation representative. As another example, when the original episode image file is the low-capacity second type of file, it is also possible to convert the low-capacity second type of file into the high-capacity first type of file.

The high-capacity first type of file may be, for example, a photoshop document (PSD) file, a Clip file (clip studio file), etc., while the low-capacity second type of file may be, for example, a JPG or PNG file, etc. However, the present invention is not limited to the examples of the first type and the second type of file, and they may be transformed into various forms. For example, as technology advances, other files may be applied to the high-capacity files presented as examples, in addition to PSD files or Clip files. In addition, as the low-capacity file, a different file may be applied as needed.

Further, in the present invention, to allow the lettering representative to intuitively recognize a translated language and a lettering task position, a third type of file in which a first language is matched with the translated language of the first language may be provided to a lettering designer. The third type of file may be, for example, a document file. The document file may be, for example, an Excel file or a Word file, and may be transformed into various forms. Hereinafter, a case where the third type of file is an Excel file will be described as an example.

The management server 120 may manage various types of files generated in the translation process by mapping (or matching) the various types of files to each other, with respect to original content episodes. Such mapped information may be used to review whether the translation is correct by comparing a translated output with the original content.

The translation server 110 may perform the role of providing a customized environment to each representative so that the translation process, from the setting of representatives of the translation process to translation, lettering, and review tasks, may be performed.

The translation server 110 may set task steps (or task processes) and task representatives for the translation process of a specific episode through the designation by an operator account or a manager account.

In the present invention, tasks included in the translation process may include at least one of i) a translation (or inputting translated language), ii) an editing review in which a translated language is modified and input, iii) a proofreading review, which uses messages on the translated language to provide feedback, iv) lettering, which changes the characters of an original content episode into the translated language, or v) an image review (lettered file review, final review, or QA review), which verifies an image reflecting the translated language.

In the operator account or manager account, representatives for the translation process of a content episode may be designated on a task-by-task basis (a task-unit basis) (e.g., translation task-‘representative A’, lettering task-‘representative B’), while deadlines may be designated on an episode basis.

The translation server 110 may provide a translation editor (a translation tool that allows each task included in the translation process to proceed) to a terminal 200 of a translation process representative (or representative account or user account of the representative). Such a translation editor may provide translation support tools (e.g., memory, glossary) as well as features (image review, file format conversion, inbox messages, feedback, image comparison function, and the uploading of translated episodes after the completion of lettering tasks).

The system 100 for performing content translation according to the present invention may be connected to at least one terminal 200 via wired or wireless communication. As illustrated in FIG. 1, the terminal 200 refers to an electronic device, and may be a smartphone, notebook computer, laptop computer, slate PC, tablet PC, ultrabook, desktop computer, and the like, without limitation on types. The service provided in the present invention may be used through the terminal 200 logged in with a user account registered on the management server 120. For example, a translator responsible for the translation of an episode may be provided with a translation editor through a terminal 210 (which also may be referred to as a translator terminal) logged in with his or her user account, and may proceed with a task of translating the language of a first country included in the episode into the language of a second country using various functions provided in the translation editor. As another example, a lettering representative (lettering designer), responsible for lettering (sketching, drawing, or designing) a translated language into an episode, may be provided with a translation file using a terminal 220 (which also may be referred to as a lettering designer terminal) logged in with his or her user account. Accordingly, in the present invention, “user,” “representative (e.g., translator),” “user account (e.g., translator account),” and “terminal (e.g., translator terminal)” may be used interchangeably.

As illustrated in FIG. 2A, a process of transmitting a translation target manuscript for an episode of content created based on the language of the first country from the management server 120 to the translation server 110 may proceed (S210).

As described above, the original content (or original work content) may exist to be stored in the management server 120, and on the basis of at least one episode of the original content being specified as a translation target, the management server 120 may provide a file of the specified episode as a translation target manuscript to the translation server 110.

In this case, the management server 120 may transmit a first type of file (e.g., PSD, Clip, etc.) including a plurality of layers to the translation server 110 (S210b, see FIG. 2B).

The first type of file may have layers separated by different elements (e.g., background, character, text, speech bubbles, etc.), and the management server 120 may provide the first type of file to the translation server 110 so that changing the language of the first country to the language of the second country may be done more easily.

In the present invention, a process in which the translation server 110 provides a translation target manuscript to a first terminal and receives, from the first terminal, a translated language corresponding to the language of a second country, which is different from the language of a first country, on the basis of the translation target manuscript, may proceed (S220, see FIG. 2A).

The translation server 110 may identify a translation representative of a translation target manuscript and provide the translation target manuscript to the first terminal 210 (translator terminal) logged in with a translation representative account.

Matching information on translation process representatives (e.g., translation representative, lettering design representative, etc.) for a specific episode may exist in the database (DB) of the translation server 110. A representative may be designated by a manager, and the translation server 110 may refer to the database (DB) to provide information necessary for tasks to representatives corresponding to the process in which the translation is being carried out. The details regarding the designation of a representative by a manager will be described below.

The translation server 110 may convert the first type of translation target manuscript into a second type of file, which is different from the first type, and provide the second type of file to the first terminal 210 (translator terminal) (S220b, see FIG. 2B).

As such an example, the translation server 110 is configured to allow a file format to be changed in the operator account and manager account, depending on a file format type obtainable from a content writer or on a file format type that is more suitable for translation. Hereinafter, an example will be given of a process of converting a high-capacity file of a first type into a low-capacity file of a second type. However, this is merely an example, and it is also possible to convert a low-capacity file into a high-capacity file as needed. In such a case, the management server transmits the second type of translation target manuscript to the translation server, and the translation server 110 may convert the second type of translation target manuscript into the first type of file, which is different from the second type, and provide the converted first type of file to the first terminal.

Additionally, as described above, the first type of file may be, for example, a photoshop document (PSD) file, a Clip file (clip studio file), etc., and this may be substituted with various other types of files. In addition, the low-capacity second type of file may be, for example, a JPG or PNG file, but this may also be substituted with various other types of files.

The first type of file (e.g., PSD, Clip, etc.) is composed of a plurality of layers, which makes it easy to be modified, but may be a high-capacity file. Since the translation representative is not responsible for carrying out modification tasks on the translation target manuscript, the high-capacity first type of file is not needed. Therefore, the translation server 110 may convert the translation target manuscript from the first type of file into the second type of file with a smaller capacity than the first type, and provide the converted second type of file to the first terminal 210 (translator terminal) for efficient data communication.

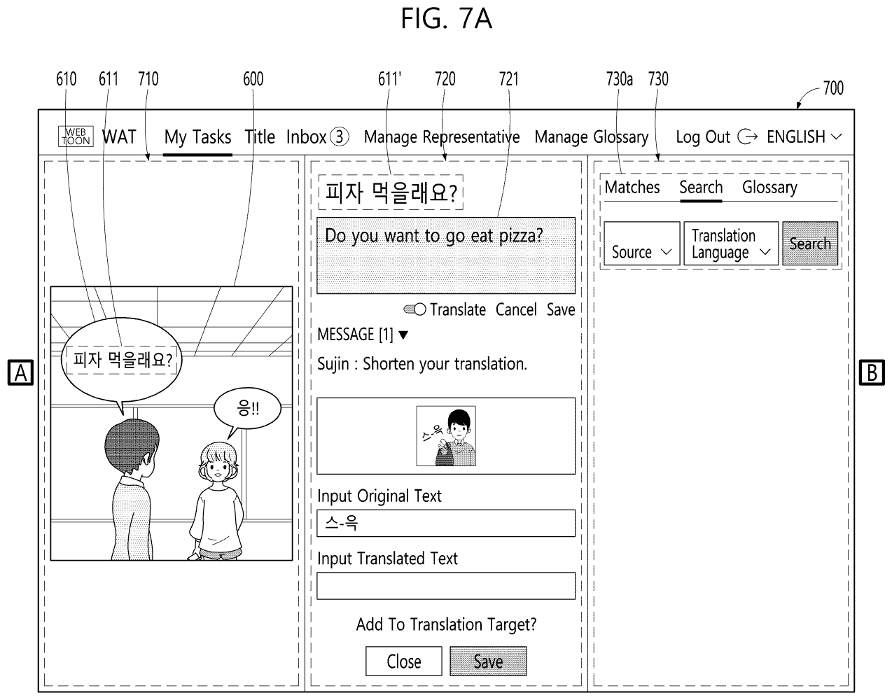

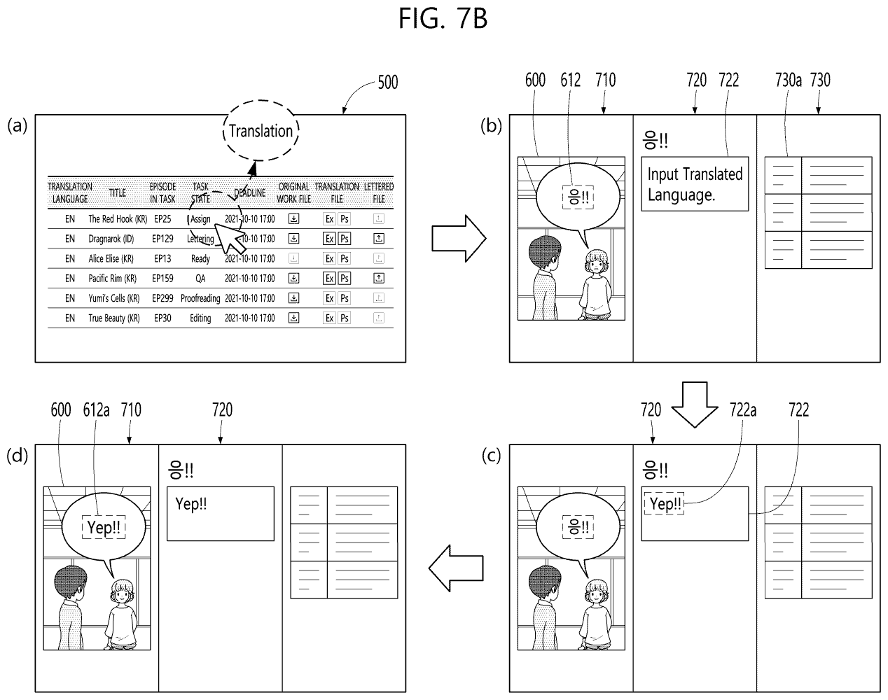

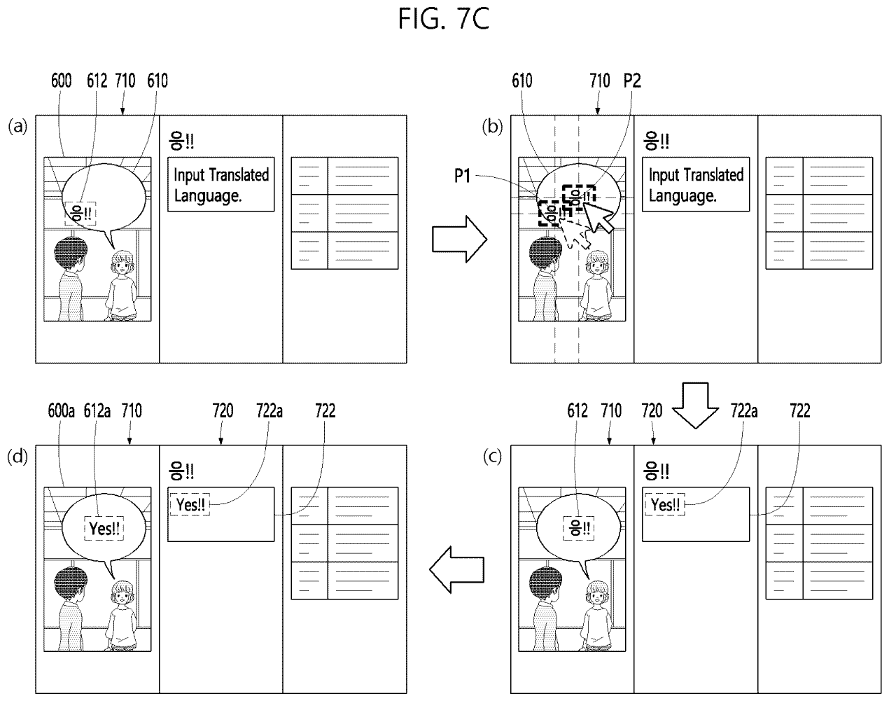

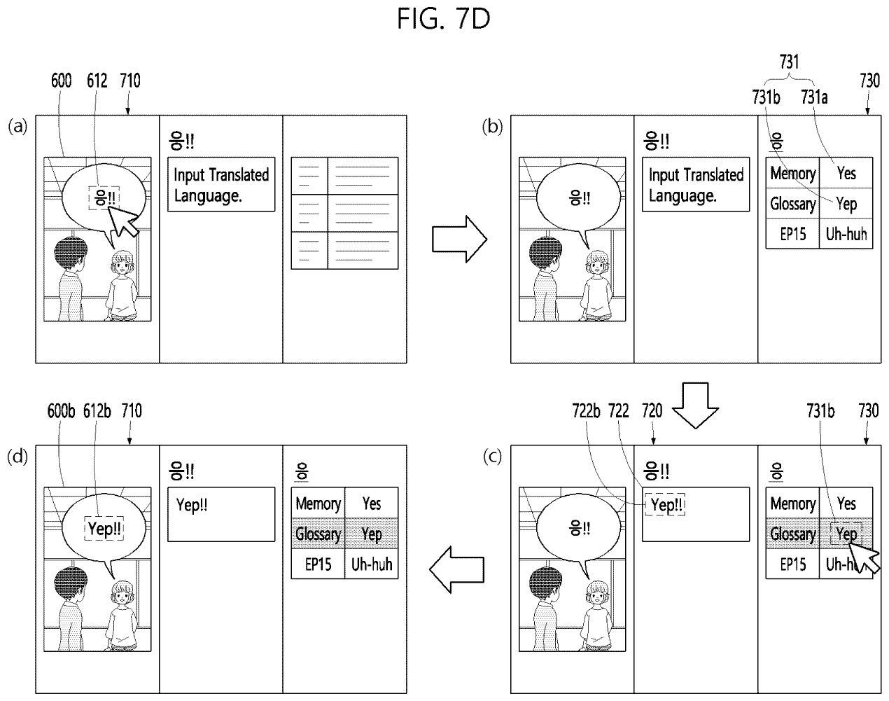

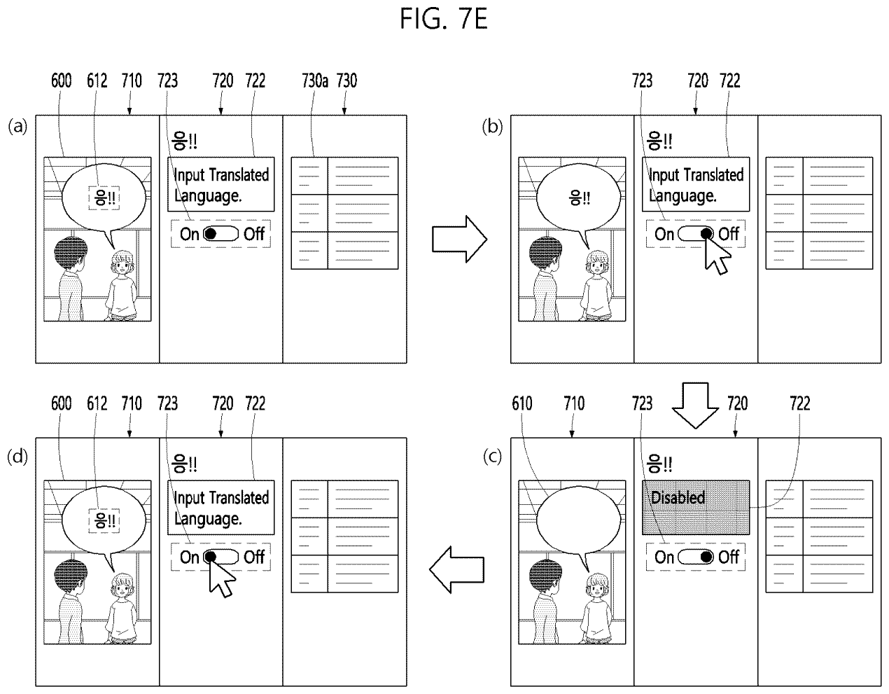

The translation server 110 may provide the first terminal 210 (translator terminal) with a translation editor that includes the translation target manuscript converted into the second type of file (see reference numeral “700” in FIG. 7A). As described above, the translation editor is an interface for an efficient task environment for representatives, and further details will be described below.

On the first terminal 210 (translator terminal), the translation target manuscript converted into the second type of file is displayed, and a translated language (e.g., “Do you want to go eat pizza?”, 310a) corresponding to the language of the first country included in the translation target manuscript (e.g., “ [symbol] ?”, 310) may be input. The translation server 110 may receive the translated language on the basis of the translated language being input into the first terminal 210 (translator terminal) (S221b, see FIG. 2B).

Further, in the present invention, a process of generating a translation file for the translation target manuscript using the translated language received by the translation server may proceed (S230, see FIG. 2A).

The translation server 110 may generate a translation file for the translation target manuscript using the translated language received from the first terminal 210 (translator terminal).

In the present invention, the “translation file” may refer to a file provided to the lettering design representative responsible for a lettering task of the translated language.

A lettering designer, on the basis of the translation file, may be responsible for a task of changing the language of the first country to the language of the second country on a character layer among the plurality of layers in the translation target manuscript. The lettering designer needs to input (create, design, or sketch) the translated language in an area where the language of the first country was positioned, and it is very important for the lettering designer to intuitively recognize matching relationship between the language of the first country and the language of the second country, which is the translated language.

The translation server 110 may generate a translation file in which the language of the first country and the translated language of the second country are each matched, so that the lettering designer may intuitively recognize the relationship between the language of the first country and the translated language corresponding to the language of the first country (see FIG. 4D).

In this case, the translation server 110 may generate the translation file as at least one of a first type of file (e.g., PSD, Clip, etc.) or a third type of file (e.g., Excel) (S240b, see FIG. 2B). That is, the translation server 110 may set different formats of image files for the first terminal 210 (translator terminal) and the second terminal 220 (lettering designer terminal), and provide the translation target manuscript accordingly. Therefore, representatives may be provided with files in a format optimized for their tasks.

Further, in the present invention, the translation server 110 may provide the translation file to the second terminal (S240, see FIG. 2A).

The translation server 110 may identify a responsible lettering designer for the translation target manuscript by referring to the database (DB), on the basis of the process in which the translation is being carried out corresponding to a lettering process. The translation server 110 may transmit the translation file to the second terminal 220 (lettering designer terminal) logged in with the account of the responsible lettering designer. For example, the translation server 110 may provide both the first type of translation file (e.g., PSD, Clip, etc.) and the third type of translation file (e.g., Excel) to the second terminal 220 (lettering designer terminal) (S240b, see FIG. 2B), and the lettering designer may proceed with the lettering task by selecting a desired type of translation file between the first type and the third type.

The translation process further includes a “review” task process, and a review task may further include an editing review and a proofreading review performed between the translation task and the lettering task, as well as an image review performed after the lettering task. Further details regarding the entire process, including the review process, will be described below.

A process of receiving an image file corresponding to the episode, translated into the language of the second country using the translation file, from the second terminal 220 may proceed (S250, see FIG. 2A).

The translation server 110 may provide the second terminal 220 (lettering designer terminal) with the translation file and the first type of translation target manuscript file.

In the second terminal 220 (lettering designer terminal), on the basis of the translation file, the task of changing the characters of the language of the first country included in a character layer among the plurality of layers that make up the translation target manuscript file to the translated language, which is the language of the second country may be carried out. In the second terminal 220 (lettering designer terminal), an image file including the language of the second country may be generated (S250b), and the translation server 110 may receive the image file.

In the image file received from the lettering designer terminal 220, the characters of the episode have been changed to the language of the second country, which is different from the first country, and in the present invention, this may be referred to as a “lettered file.” In the translation server 110, a translated episode for the content episode may be generated using the lettered file (S260b, see FIG. 2B).

Meanwhile, the system 100 may operate a translation platform in linkage with the authority server 130, management server 120, and translation server 110 to specify content works that require translation, set translation, lettering, and review representatives for the specified content, and ensure that tasks are carried out by the representatives according to the order of the tasks. Hereinafter, the entire translation process that proceeds in the present invention, from specifying the work to reviewing, will be described.

As illustrated in FIG. 3A, the authority server 130 may manage user accounts and authorities (S301). The authority server 130 may assign an operator account, which holds the operation authority for the translation process, to a specific user on the basis of an operator account assignment request.

In the present specification, an “operator (or operator account)” may have authority over at least one of several designating managers, managing the translation target manuscript, managing translation process representatives, and managing translation support tools (e.g., glossary).

In the authority server 130, a work group may be generated (S302, see FIG. 3A). Further, on the basis of the work group being generated in the authority server 130, at least one of the authority server 130 or the management server 120 may generate content and episodes based on the work group (S303, see FIG. 3A). Work groups, content, and episodes may be generated in sequence, and on the basis of the content and episodes being generated, information on the content and episodes may be linked to the translation server 110 (S304, see FIG. 3A).

Information on the content and episodes may vary widely. As described above, the content may be made up of a plurality of episodes, and episode information according to a predefined order (e.g., upload order) may exist to be matched with the plurality of episodes. For example, the plurality of episodes that make up a specific content titled “Yuna's Cells” may have episode information matched according to the upload order, such as Episode 1 (ep. 1), Episode 2 (ep. 2), and Episode 3 (ep. 3). Various types of information, such as content (e.g., content title information), episodes making up the content (e.g., episode files), and episode numbers, are matched with each other. In the management server 120 and translation server 110, the information on the content and episodes may continuously be linked and updated.

Meanwhile, when the content and episodes are generated in the management server 120, a setting function (or title registration function) for registering the translation target content may be activated in the translation server 110 (S305, see FIG. 3A).

As illustrated in FIG. 4A, a service page 400a provided to the operator account may include translation target content and a setting function (or setting function area 410) for setting the types of languages for the first country and the second country for the translation target content. The translation server 110, through the setting function 410, may receive content title information (e.g., “Yumi's Cell”), information on the type of language for the first country for the content (or original work language code, e.g., KR), and information on the type of language for the second country (or translated work language code, e.g., EN). The translation server 110 may specify translation target content and the first country language and second country language of the translation target content on the basis of the information received through the setting function 410.

The operator account includes the authority to register managers, and in the translation server 110, on the basis of receiving a manager registration request for a specific user account from the operator account, the specific user account may be registered as a manager (S306, see FIG. 3A).

The manager may set task processes and task representatives for the translation process of an episode.

As illustrated in FIG. 4A, the translation server 110 may receive a manager registration request, including information 420 on a specific user account, from the operator account through the service page 400a. The manager registration request may include the manager's name. In addition, in case that the registration of a plurality of managers is requested for a single content, the manager registration request may include information in which the names of each of the plurality of managers are matched with episodes that managers are responsible for.

The translation server 110 may register the task processes and task representatives for the translation process of an episode by setting the task processes and task representatives through either the operator account or the manager account (S308, see FIG. 3A).

Depending on whether the task representative registration is carried out by the operator account or the manager account, the management server 120 and the translation server 110 may proceed with interworking between user accounts (Teammate interwork) (S307, see FIG. 3A).

In the management server 120 and the translation server 110, when a representative registration request is received from the operator account, the requested user may be registered as a representative without the user account interworking process. In contrast, in the management server 120 and the translation server 110, the registration of a representative may proceed only for user accounts that are interworked with the manager account. The management server 120 and the translation server 110 may proceed with the registration of a representative only after interworking with the user account through a Teammate invitation when the manager account and the corresponding user account are not already in an interwork relationship.

Hereinafter, for convenience of description, an example will be provided in which the representative registration is carried out by the manager account, and user account interworking between the manager and the representative has been completed.

The translation process may include at least one of a plurality of task processes, and the translation server 110 may provide a translation task interface corresponding to a task process to the representative terminal of the task process.

As illustrated in FIG. 4A, the translation server 110 may replace the translation target manuscript. When the specific graphic object 432a is selected from the operator account, the translation server 110 may provide the translation target manuscript before modification (existing image A, FIG. 4B), and the translation target manuscript after modification (modified image B, FIG. 4B) to the operator account.

As illustrated in FIG. 4C, the task process (or task step, 440) included in the translation process in the present invention may include at least one of i) translation (or inputting translated language, Translation, 441), ii) an editing review (Editing, 442) in which the translated language is modified and input, iii) a proofreading review (Proofreading, 443) which uses messages on the translated language to provide feedback, iv) lettering (Lettering, 444), which changes the characters of the original content episode into the translated language, or v) an image review (QA, 445), which verifies an image reflecting the translated language.

The translation server 110 may configure the translation process to include at least one of the plurality of task processes 441 to 445 by the manager account. In the manager account, the translation process may be configured in various ways depending on the based on the episodes, translation companies and other factors. For example, as illustrated in FIG. 4C, the translation server 110 may configure the process to include only translation, lettering, and image review tasks (Translation-Lettering-QA, 451), or configure the process to include all tasks such as translation, editing review, proofreading review, lettering, and image review (Translation-Editing-Proofreading-Lettering-QA, 452).

The translation server 110 may specify the representative for the task process on the basis of the task process for the episode of the content being specified. The translation server 110 may match the task process (e.g., Translation, 461a), the representative (user account, 461b), and the assigned episode (episodes 1-20, 461c), and store them in the database as a representative dataset 461. The translation server 110 may configure a representative dataset 461 or 462 for each task process of an episode on the basis of the information received from the manager account and store the representative dataset in the database. Further, in the process in which the translation is being carried out for an episode, the translation server 110 may refer to the database to identify the representative for the current task process.

As illustrated in FIG. 4D, the manager account may be provided with a management page 400d related to managing the translation process of an episode. The manager may perform overall task management of the translation process, management for the representatives, and management for deadlines through the management page 400d. To this end, the management page 400d may include a list of translation target content 470 allocated to the manager account, information on each representative for the task processes of the translation process 480, information on the task progress status for each episode, a deadline setting function, functions for registering and modifying notices, and a file upload function, and the like.

In the management server 120, the upload of the translation target manuscripts for each episode of the content may be carried out (S309, see FIG. 3B). For example, the management server 120 may receive a translation target manuscript from a writer account (or writer terminal) that creates the content episodes and upload the translation target manuscript to the database of the management server 120. As another example, the management server 120 may receive a translation target manuscript from a content upload representative account (or representative terminal) and upload the translation target manuscript to the database of the management server 120. The method by which the translation target manuscript is uploaded to the management server 120 may vary.

The management server 120 may transmit the translation target manuscript to the translation server 110 to proceed with the translation process for the translation target manuscript, in linkage with the translation server 110 (S310, see FIG. 3B).

In this case, the translation server 110 may change a file format of the translation target manuscript provided to the first terminal 210 (translator terminal) to a different format type. Such a file format may be converted by the operator account or the manager account as a more suitable type for translation.

For example, the translation server 110 may proceed with the task of converting the translation target manuscript received from the management server 120 into a low-capacity format (S311, see FIG. 3B). However, in this example, converting to a low-capacity format is merely an example, and it is also possible to convert to a high-capacity format as needed, or to make changes regardless of the file capacity on the basis of the translator's opinion or the like.

As described above, in the present invention, content episodes may be configured of a first type of file that includes a plurality of layers. The first type of file may have layers separated by different elements (e.g., background, character, text, speech bubbles, etc.), and the management server 120 may provide the first type of file to the translation server 110 so that changing the language of the first country to the language of the second country may be done more easily. The first type of file is composed of a plurality of layers, which makes it easy to be modified, but may be a high-capacity file. Since the translation representative is not responsible for carrying out modification tasks on the translation target manuscript, the high-capacity first type of file is not needed. Therefore, the translation server 110 may convert the translation target manuscript from the first type of file into the second type of file with a smaller capacity than the first type, and provide the converted second type of file to the first terminal 210 (translator terminal) for efficient data communication.

Further, in the translator terminal (first terminal, 210), the translated language corresponding to the language of the first country included in the translation target manuscript may be input (S312, see FIG. 3B). The translation server 110 may provide the translator terminal 210 with a translation editor (see reference numeral “700” in FIG. 7A) that includes a translated language input function. The translation editor 700 may include an input window capable of translated language input.

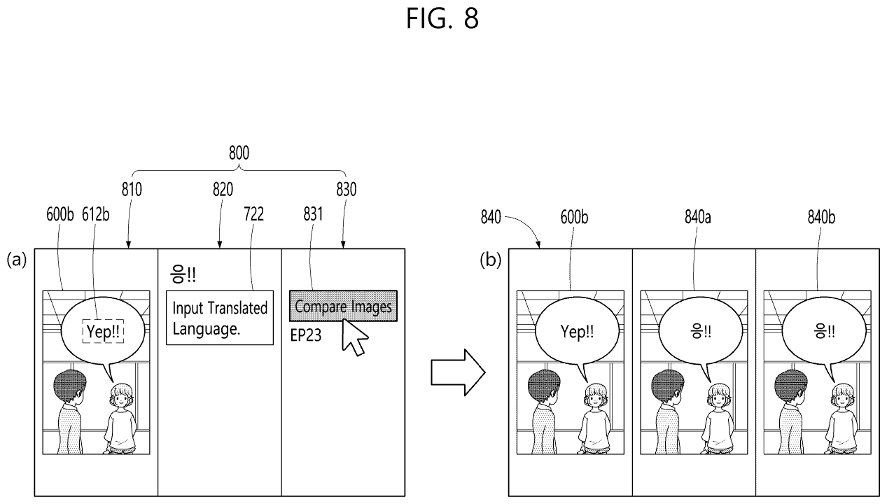

The translation server 110 may provide the reviewer terminal 230 with a review editor (see reference numeral “800” in FIG. 8) that includes the translated language, so that a review on the translated language may be conducted (S313, see FIG. 3B). More specifically, the translation server 110 may provide the reviewer terminal 230 with an original image corresponding to the translation target manuscript and an image converted into the translated language, so that a review on the translated language received from the terminal of the translation representative may be performed.

As described above, the review process for reviewing the translated language may include an “editing review” that modifies and inputs the translated language, a “proofreading review” that uses messages on the translated language to provide feedback, and an “image review (or QA review)” that performs a review of the lettered file. The review task process being described in the current process may correspond to an “editing review task” that modifies and inputs the translated language.

The reviewer terminal 230 may compare the original image with the image displaying the translated language and perform an editing review by modifying the translated language (S314, see FIG. 3B).

Further, a proofreading review task, which uses messages on the translated language to deliver feedback to the translation representative, may proceed. A proofreading review representative may be the same user as an editing review representative or a different user. The translation server 110 may transmit a message to the translator terminal 210 on the basis of receiving the message including feedback information on the translated language from a proofreading reviewer terminal 230. The translation server 110 may display the feedback information received from the proofreading reviewer terminal 230 in one area of the translation editor 700. In this case, the translation server 110 may display the feedback information in the area surrounding the translated language (e.g., “Do you want to go eat pizza?”) that is the subject of the feedback.

The translation server 110 may generate a translation file for the translation target manuscript on the basis of the review of the translated language being completed (S315, see FIG. 3B).

In the present specification, the “translation file” may refer to a file provided to the lettering design representative responsible for a lettering task of the translated language.

The translation server 110 may generate the translation file as at least one of a first type of file or a third type of file. The lettering designer needs to input (create, design, or sketch) the translated language in an area where the language of the first country was positioned, and it is very important for the lettering designer to intuitively recognize matching relationship between the language of the first country and the language of the second country, which is the translated language. Accordingly, in the present invention, the translation file may be generated as a third type of file having a table structure and provided to the lettering designer.

In the second terminal 220 (lettering designer terminal), a lettered file may be generated using the translation file (S316, see FIG. 3B). In the second terminal 220 (lettering designer terminal), on the basis of the translation file, a task may be performed where the characters of the language of the first country, included in the character layer among the plurality of layers that make up the translation target manuscript file, is changed to the translated language, which is the language of the second country. The lettering designer terminal 220 may transmit and upload the lettered file to the translation server 110 (S317, see FIG. 3B). The lettered file may be configured of a first type of file consisting of a plurality of layers.

The translation server 110, upon the upload of the lettered file, may allow a final review of the lettered file to be conducted on the reviewer terminal 230 of the image review representative (S318, see FIG. 3B). Although FIG. 3B illustrates the reviewer terminal 230 for the editing review, proofreading review, and image review (or final review) collectively as “reviewer terminal 230” without distinction, the representatives for the editing review, proofreading review, and image review (or final review) may be different. In this case, the reviewer terminals 230 may also differ.

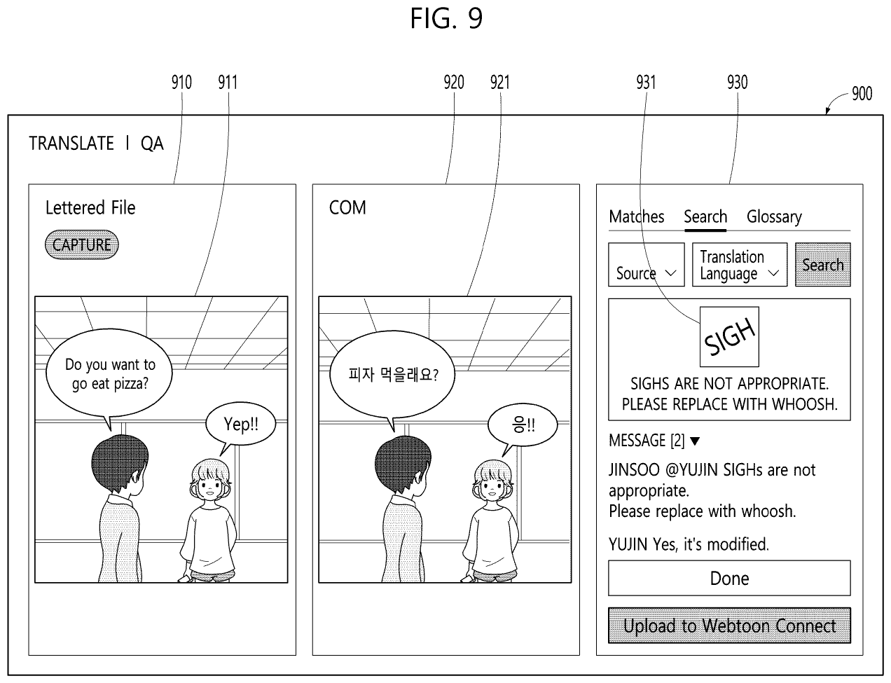

The translation server 110 may provide the image reviewer terminal 230 with a QA editor (see reference numeral “900” in FIG. 9) so that a final review of the translated episode converted into the translated language may be conducted. The QA editor 900 may include an image file of the episode created based on the language of the first country (original image file or image file of the translation target manuscript) and the lettered file converted into the language of the second country (or translated episode image file). The image reviewer terminal 230 may compare the images of the files output in the QA editor 900 and proceed with the final review of the translated episode (S318, see FIG. 3B).

On the basis of the final review of the translated episode having been completed, the translation server 110 and the management server 120 may generate a translated episode corresponding to the episode created based on the language of the first country by using the lettered file created based on the language of the second country (S319, see FIG. 3B).

As described above, the system 100 for performing content translation according to the present invention may provide content translation representatives with the necessary information and user environment for translation tasks, on the basis of interworking of the authority server 130, management server 120, and translation server 110. The representatives may easily proceed with content translation tasks using the task environment provided by the system 100 for performing content translation. Accordingly, the “system for performing content translation” according to the present invention may also be referred to as a “content translation platform” or a “content translation system.”

In addition, in order to provide the content translation representative with a user environment optimized for translation tasks, the present invention illustrates a new form of translation editor and review editor.

Hereinafter, a method of translating content will be described in more detail, focusing on the user environment provided by the present invention.

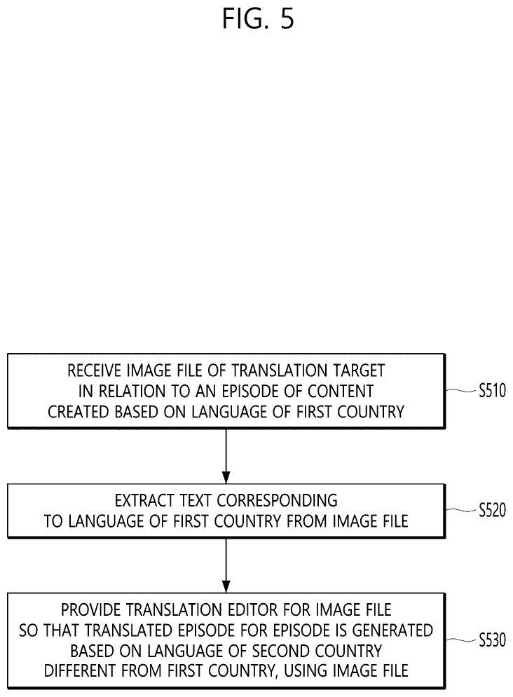

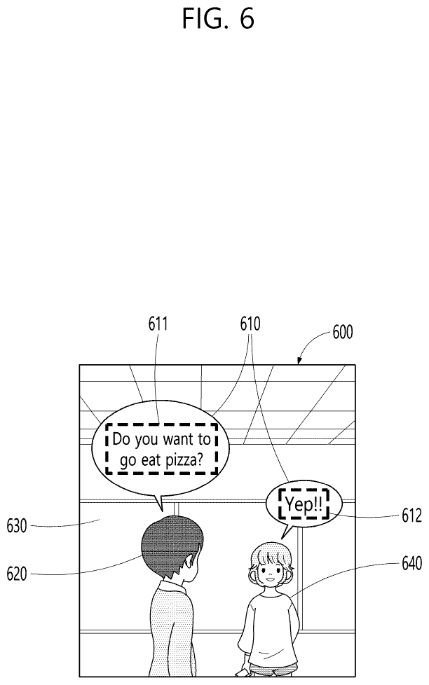

FIG. 5 is a flowchart for explaining a method of translating content in the system 100 for performing content translation according to the present invention, FIG. 6, FIG. 7A, FIG. 7B, FIG. 7C, FIG. 7D, and FIG. 7E are diagrams for explaining a translation editor provided in the present invention, and FIG. 8 and FIG. 9 are diagrams for explaining a review editor provided in the present invention.

In the present invention, with reference to an episode of content created based on the language of the first country, a process of receiving an image file of a translation target may proceed (S510, see FIG. 5).

The translation server 110 may receive an image file of an episode, which is a translation target, from the management server 120.

In the management server 120, episodes of specific content created based on the language of the first country (“source language,” “original work language,” or “translation target language”) may be registered and present. The management server 120 may register and manage the image files of episodes in a database, and provide the image files to the translation server 110 on the basis of being specified as translation targets.

In the present invention, a process of extracting text corresponding to the language of the first country from the image file may proceed (S520, see FIG. 5).

The translation server 110 may use various algorithms trained to recognize and detect text (or characters) included in an image to extract at least one text included in the image file of a translation target episode.

For example, as illustrated in FIG. 6, the translation server 110 may, through an optical character reader (OCR), extract text (e.g., “ [symbol] ?”, “ [symbol] ”, 611 and 612) corresponding to the language of the first country (e.g., “Korean”) from an image file 600 of a translation target episode.

The translation server 110, when extracting text included in the image file 600 of the translation target episode through the optical character reader (OCR), may also extract position information on the text.

Here, “position information on the text” may be understood as information regarding where the text is positioned within the translation target episode image file 600. As such an example, coordinate information on the extracted text within the entire image of the episode may be stored as the position information.

The translation server 110 may extract the text 611 and 612 corresponding to the language of the first country and the position information on the text from the translation target episode image file 600 through the optical character reader (OCR). The text and the position information are matched with each other by the translation server 110, and configured as a paired data set.

The translation server 110 may extract the text corresponding to preset criteria from the image file 600 of the translation target episode into the translation target language. In the present invention, the image file 600 of the translation target episode may include a plurality of graphic objects 610, 620, 630, 640. The translation server 110 may extract, as the translation target language, text 611 and 612 included in a specific graphic object (e.g., speech bubble graphic object, 610) among the plurality of graphic objects 610, 620, 630, 640 included in the image file 600 of the translation target episode, which corresponds to the preset criteria.

More specifically, the translation server 110 may primarily identify the speech bubble graphic object 610 within the image file 600 of the translation target episode, and then, secondarily, extract the text 611 and 612 included in the speech bubble graphic object 610, along with position information on the text, through the optical character reader (OCR). Hereinafter, for convenience of description, the image file of the translation target episode will be interchangeably described as the “translation target image file” or “translation target image.”

In the present invention, a process may proceed to provide a translation editor for the image file so that a translated episode of the episode is generated based on the language of the second country, which differs from the language of the first country, using the image file (S530, see FIG. 5).

The translation server 110 may provide the translator terminal 210 with a translation editor for the translation representative using an episode image file that is a translation target, along with text extracted from the image file and position information on the text.

As illustrated in FIG. 7A, the translation editor 700 may have a screen consisting of a plurality of areas 710, 720, 730 in which different information is output. Among the plurality of areas, a first area 710 may output a translation target image file 600, and a second area 720 may include an input window 721 in which translated language for a text (ex: “ [symbol] [symbol] ?”, 611) extracted from the translation target image file 600 is input. Input windows matched to each of a plurality of texts (e.g., “ [symbol] ”, “ [symbol] ”, 611, 612) extracted from the translation target image file 600 may exist in the second area 720. In this case, in the second area 720, to allow the translation representative to intuitively recognize which text among the plurality of texts included in the translation target episode image file 600 is currently being worked on for translation, a specific text (e.g., “ [symbol] ?” 611′) may be output around the input window 721 that is matched to the specific text.

Further, in the third area 730, at least one translation support tool 730a may be output to support the translation task of the translation representative. The translation support tool 730a may include various functions to support the translation task. For example, the translation support tool 730a may include a glossary (or dictionary, or translated language recommendation tool, etc.) that recommends translated language on the basis of a database of the languages of the first country and the second country.

In the present invention, the first area to the third area 710, 720, 730 of the translation editor 700 may be configured so that the translation representative of the translation editor 700, while identifying the translation target image file 600, may input the translated language and easily use the translation support tool 730a as needed. For example, the translation editor 700 may be configured so that the translation target image file 600 and the translation support tool 730a are output on both side of the input window 721, with the first area 710, the second area 720, and the third area 730 of the translation editor 700 being sequentially disposed along one direction (e.g., from direction A to direction B).

The translation server 110 may receive the translated language through the input window 721 of the translation editor 700. The translation server 110 may convert the language of the first country included in the translation target image file 600 into the translated language, which is the language of the second country, to generate a translated episode.

As illustrated in diagram (a) of FIG. 7B, the translation server 110 may receive a request for specific episode translation task from the translator terminal 210. For example, the translation server 110 may provide a task page 500 to the translator terminal 210. This task to the translator. The translation server 110 may receive a request for a selected specific episode translation task based on selecting any one of the translation target episode items included in the task list.

As illustrated in diagram (b) of FIG. 7B, the translation server 110 may provide the translation editor 700 to the translator terminal 210 so that a translated episode for the translation target image file 600 of the specific episode is generated, in response to the receipt of the request for specific episode translation task from the translator terminal 210. As described above, the first area 710 of the translation editor 700 may output an image file 600 of the translation target episode, and the second area 720 may include an input window 722 for a text (ex: “ [symbol] ”, 612) extracted from the translation target image file 600. In addition, the third area 730 may output the translation support tool (ex: a glossary, 730a).

As illustrated in diagram (c) of FIG. 7B, the translation representative may input the translated language (ex: “Yep!!”, 722a) into the input window 722 for the text (ex: “ [symbol] !!”, 612) extracted from the image file while viewing the translation target image file 600 through the translation editor 700.

In response to the input of the translated language 722a into the input window 722, the translation server 110 may convert the text 612 extracted from the image file into a text corresponding to the translated language in the image file and display it in the first area 710 as illustrated in diagram (d) of FIG. 7B. As described above, the second area 720 may include input windows matched to each of the plurality of texts extracted from the translation target image file 600. In response to the receipt of translated language through the input window matched to a specific text among the plurality of input windows, the translation server 110 may convert the specific text included in the translation target image file 600 into the translated language. For example, as illustrated in diagram (d) of FIG. 7B, in response to the input of the translated language “Yep!!” (722a) for the input window 722 matched to the text “ [symbol] ” (612), the translation server 110 may convert the text “ [symbol] !!” (612) included in the translation target image file 600 into “Yep!!” (612a) which is the language of the second country corresponding to the translated language. In addition, the translation server 110 may display an image file in which the language of the first country is converted into the translated language, which is the language of the second country, in the first area 710.

Further, the translation server 110 may convert an episode created based on the language of the first country into the language of the second country using the translated language received by the translation editor 700 through the input window 722 to generate a translated episode.

As such, in the present invention, the first area 710 and the second area 720 of the translation editor 700 may interwork with each other so that a converted episode is generated and displayed by interworking with the input of the translated language. The translation representative may identify the appearance of the translated language he/she inputs in real time while inputting the translated language.

In accordance with an embodiment of the present invention, a movement guide for receiving control instructions for the position movement of the text may be output in the first area 710 so as to enable the position movement of the text corresponding to the translated language.

The translation editor 700 according to the present invention may provide a text position movement function within the translation target image file 600 during the translation process. The text position movement may be performed under various situations during the translation process. There may be a case where the position movement of a text corresponding to the language of the first country is required in the translation target image file (original image file) or a case where the position movement of the translated language is required depending on a change in the length of the translated language.

For example, as illustrated in diagram (a) of FIG. 7C, when it is assumed that, on the translation target image file 600, a text (“ [symbol] ”, 612) created in the language of the first country is positioned beyond a certain location (ex: center area) within the speech bubble graphic object 610, the translated language is also positioned in the position of the text (“ [symbol] !”, 612) created in the language of the first country, and the translation representative may move the position of the text (the text corresponding to the translated language) during the translation process.

More specifically, as illustrated in diagram (b) of FIG. 7C, the translation server 110 may receive control instructions (ex: drag) for the position movement that moves the text (“ [symbol] ”) from a first position (P1) to a second position (P2) through the first area 710. As illustrated in diagram (c) of FIG. 7C, in response to the control instructions for the position movement, the translation server 110 may move and arrange the text (“ [symbol] ”) from the first position (P1) to the second position (P2). In addition, as illustrated in diagram (d) of FIG. 7C, in response to the input of the translated language (“Yes!!,” 722a) through the input window 722 matched to the text (“ [symbol] ”), the translation server 110 may control the translated language 612a to be displayed in the changed second position (P2), as shown in diagram (d) of FIG. 7C.

As another example, when the lengths of the languages of the first country and the second country are different, the position movement of the translated language (or the text corresponding to the translated language) may be required within the speech bubble graphic object. More specifically, the text consisting of the language of the first country may be composed of the five characters “ [symbol] ”, and the translated language for the text may be composed of the 31 characters “I love you so much, beyond measure.” When “I love you so much, beyond measure” is arranged at the position of “ [symbol] ”, the text is directed to one side within the speech bubble graphic object, which may deteriorate the aesthetics and readability of the content. Accordingly, the translation representative may move and adjust the position of the translated language (or the text corresponding to the translated language) output in the first area 710. In response to the reception of control instructions for the position movement of the translated language (or the text corresponding to the translated language) in a state in which the translated episode converted into the translated language is being output in the first area 710, the translation server 110 may output the translated language (or the text corresponding to the translated language) by arranging them at a changed position. Since the method of moving the position of the translated language is the same as the method (ex: drag) for moving the position of the text “ [symbol] ” described above, detailed descriptions thereof are omitted.

According to one aspect of the present invention, a translation support tool 730a for supporting the translation task of a translator may be provided in a third area 730 of the translation editor 700. The translation support tool 730a may include a glossary that recommends translated language for a text extracted from a translation target image based on a database for the language (or source language) of the first country and the language (or target language) of the second country. As another example, the translation support tool 730a may include the function for identifying the grammar of the translated language based on the database. Hereinafter, for the convenience of explanation, the “glossary” that recommends the translated language will be explained as an example of the translation support tool.

When the translation server 110 receives an input for selecting any one of the texts output on the first area 710 of the translation editor 700, the first area 710 or the third area 730 may be interworked and controlled such that a list for recommending the translated language for the selected text is output on the third area 730.

More specifically, as illustrated in diagram (a) of FIG. 7D, a translation target image file 600 may be in the first area 710 of the translation editor 700. The translation server 110 may receive a user input for selecting a specific text (ex: “ [symbol] ”, 612) among a plurality of texts included in the translation target image file 600 in a state in which the translation target image file 600 is output on the first area 710.

As illustrated in diagram (b) of FIG. 7D, the translation server 110 may output a recommendation list (or glossary, 731) including the recommended translated language for a specific text (ex: “ [symbol] ”, 612) on the third area 730 in response to a user input for selecting the specific text.

The recommended translated language included in the recommendation list 731 may correspond to at least one of a first type of recommended translated language 731a or a second type of recommended translated language 731b based on their relevance to specific content constituting the episode.

The first type of recommended translated language 731a may be specified based on a first type of database (general DB) built based on a plurality of contents registered in the management server 120. This first type of recommended translated language 731a may include the same translated language “Yes” for the same text “ [symbol] ”, regardless of the translation target episode (or content).

The second type of recommended translated language 731b is specified based on a second type of database (DB for each work) built based on specific content (ex: “Yuna's Cell”), and even for the same text “ [symbol] ”, it may include different translated language (e.g. “Yep”) depending on the translation target episode (or content).

When any one translated language is selected from the recommendation list, the translation server 110 may control the input window such that the selected translated language is input to the input window in response to the selection. As illustrated in diagram (c) of FIG. 7D, the translation server 110 may receive a user input for selecting any one recommended translated language (ex, “Yep”, 731b) from the recommendation list 731 through the third area 730. The translation server 110 may interwork with the second area 720 and the third area 730 so that, in response to the user input for selecting any one recommended translated language (“Yep”, 731b), the selected recommended translated language “Yep” is input to the input window 722 of the second area 720. In this case, the translation server 110 may control the input window 722 matched to the corresponding text (ex: “ [symbol] ”, 612) of the recommended translated language 731b such that the recommended translated language 731b is input to the input window 722. As described above, the translation target image file 600 may include a plurality of texts, and the second area 720 may include the input windows matched to each of the plurality of texts. The recommended translated language (“Yep”, 731b) corresponds to a specific text (“ [symbol] ”, 612) among the plurality of texts, and the translation server 110 may control the input window 722 matched to the specific text such that the recommended translated language 722b is automatically input only by selecting the recommended translated language (“Yep”, 731b) for the specific text.

As illustrated in diagram (b) of FIG. 7D, the translation server 110 may convert a specific text (“ [symbol] ”, 612) into a text corresponding to the recommended translated language (“Yep!!”, 612b) and output it in the first area 710, in response to the input of the recommended translated language 722b in the input window 722 matched to the specific text.

As illustrated in diagram (a) of FIG. 7E, the translation editor 700 may provide a selection icon 723 linked with a function for selecting whether to translate a text 612 extracted from a translation target image file 600. The translation server 110 may control a state of the input window 722 matched to text 612 to activation or deactivation, depending on a user input for the selection icon 723.

In this case, the selection icon 723 for selecting whether to translate a specific text 612 may be displayed (or positioned) around the input window 722 matched to the specific text (“ [symbol] !!”, 612) in the second area 720.

As illustrated in diagram (b) of FIG. 7E, the translation server 110 may receive a user input for selecting the selection icon 723 linked with a function for determining whether to translate a specific text 612 in the state in which the input window 722 matched to the specific text 612 is activated. In response to the user input, the translation server 110 may control the input window 722 matched to the specific text 612 to be deactivated.

As illustrated in diagram (c) of FIG. 7E, the translation server 110 may control a speech bubble graphic object 610 corresponding to a specific text in the first area 710 of the translation editor 700 to be output in an empty state by interworking with the deactivation of the input window 722 matched to the specific text. In other words, the translation server 110 may control the specific text (“ [symbol] !!”, 612) included in the speech bubble graphic object 610 to disappear from the first area 710.

Further, the translation server 110 may receive a user input for the selection icon 723 linked with the specific text 612 in a state where the speech bubble graphic object 610 is output in an empty state on the first area 710. The translation server 110 may receive the user input for selecting the selection icon 723 linked with a function of determining whether to translate the specific text 612 while the input window 722 matched to the specific text 612 is deactivated. As illustrated in diagram (d) of FIG. 7E, the translation server 110 may activate the input window 722 matched to the specific text 612 in response to the user input. In addition, the translation server 110 may control the speech bubble graphic object 610 including the specific text (“ [symbol] !!”, 612) to be output on the first area 710 by interworking with the activation of the input window 722.

According to an aspect of the present invention, a review process for reviewing translated language may be configured to be performed. As described above, the review process may include “editing review” for modifying and inputting the translated language, “proofreading review” for delivering feedback using a message for the translated language, and “image review (lettered file review or final review or QA review)” for performing a review of lettered file. A review editor for the editing review and the proofreading review will be described first, and then a review editor for the image review (or lettered file review) will be described.

As illustrated in diagram (a) of FIG. 8, the translation server 110 may provide a review editor 800 for reviewing extracted text and translated language. The review editor 800 may include at least one of a first area 810, a second area 820 and a third area 830. In the first area 810 of the review editor 800, an image 600b, in which a text (ex: “ [symbol] ”) extracted from the translation target image file 600 is converted into a translated language and output to the first area 710 of the translation editor 700, may be output. In addition, in the second area 820 of the review editor 800, an input window 722 output to the second area 720 of the translation editor 700 may be output. As described in diagram (d) of FIG. 7D above, by interworking with the selection of the recommended translated language 731b, an image file 600b of a translated episode converted into the recommended translated language 731b may be output to the first area 710 of the translation editor 700. In the first area 810 of the review editor 800, the image file 600b of the translated episode output to the translation editor 700 is output, and the review representative may review the translated language (for example, modifying the translated language through the input window or transmitting a feedback message to the translation representative) through the image file 600b of the translated episode.

The translation server 110 may provide a graphic object (ex: “image comparison”, 831) linked with the image comparison function to the review editor 800. For example, the translation server 110 may provide the graphic object 831 to the third area 830 of the review editor 800. As illustrated in diagram (b) of FIG. 8, the translation server 110 may provide an image review comparison window 840 to the review editor 800 in response to the selection of the graphic object 831. In this case, a review comparison window 840 illustrated in FIG. 8B may be output in the form of a pop-up to the review editor 800 and may be provided to the review representative by overlapping with a screen of the review editor 800.

Further, the review comparison window 840 may be output in the form of a pop-up to the translation editor 700 illustrated in FIG. 7A. A graphic object linked with the image comparison function may be included in the third area 730 of the translation editor 700. In response to the graphic object being selected in the translation editor 700, the translation server 110 may output the review comparison window 840 in the form of a pop-up to the translation editor 700. In this case, the review comparison window 840 may overlap with the screen of the translation editor 700 and be provided to the review representative.

The review comparison window 840 may output a first comparison target image 600b and a second comparison target image 840a and 840b. The first comparison target image 600b is an image output in the first area 710 of the translation editor 700, and may also be understood as an episode image including the translated language (“Yep!!”, 612b). The second comparison target images 840a and 840b are image files of the translation target (or the translation target manuscript), and may mean an image of a file including the text (“ [symbol] !!”) corresponding to the language of the first country. The reviewer may review the translated language by comparing the image 600b created based on the language (translated language) of the second country with the image 840a and 840b created based on the language of the first country.

According to an aspect of the present invention, a translated file and a translation target image file (or a translation target manuscript file) may be transmitted to the lettering designer (or lettering representative) terminal 220 such that a translated episode in which the translated language is lettered is generated based on the completion of the review of the translated language. In this case, lettering may mean replacing characters in the image file with characters in another language.

The lettering representative terminal 220 may be configured to perform, based on the translated file, the task of changing the language characters of the first country included in the character layer among the plurality of layers constituting the translation target image file into the translated language which is the language of the second country. The lettering representative terminal 220 may generate a translated episode file (lettered file or lettered image file) translated into the language of the second country, and the translation server 110 may receive the translated episode file (or lettered file) from the lettering representative terminal 220.

The translation server 110 may provide a final review editor to the final review representative terminal such that the final review of the translated episode file (or lettered file) may be performed. In the present invention, the final review is named “(lettered) image review” or “lettered file review” or “QA review,” and in the following description, in order to avoid confusion in the terms, it will be named “QA review.” However, it should be understood that the QA review may be replaced with the “image review” or the “lettered file review” or the “final review.”

As illustrated in FIG. 9, the translation server 110 may provide a QA editor 900 to the QA representative terminal such that a review of a translated episode translated into the language of the second country is performed. In the present invention, the QA editor 900 may be understood as a review editor in which a final review of the lettered file is performed.

In a first area 910 of the QA editor 900, a lettered image file (lettered translated episode, 911) may be output, and in a second area 920 of the QA editor 900, a translation target image file (or a translation target manuscript, 921) may be output. That is, the translation server 110 may output a translated episode in which the language of the second country is lettered in the first area 910 of the QA editor 900, and output an original episode created based on the language of the first country in the second area 920 of the QA editor 900.

The QA representative may compare the lettered translated episode with the original episode to conduct a final review as to whether the translation is accurate and whether the translated language is lettered correctly. Based on the QA review result, the QA representative may create a review list in a third area 930 of the QA editor 900. For example, the translation server 110 may create a review item including a captured image 931 in the third area 930 based on the fact that at least a part of the lettered image files (lettered translated episodes) output in the first area 910 of the QA editor 900 are captured. The QA representative may create a feedback message for the captured image 931 and transmit the feedback to the translation representative or the lettering representative.

Further, the present invention described above may be implemented as computer-readable code or instructions on a non-transitory computer readable recording medium in which a program is recorded. That is, the present invention may be provided in the form of a program.

The computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with at least one processor, that is, a central processing unit (CPU), and is not particularly limited to any type.

It should be appreciated that the detailed description is interpreted as being illustrative in every sense, not restrictive. The scope of the present invention should be determined based on the reasonable interpretation of the appended claims, and all of the modifications within the equivalent scope of the present invention belong to the scope of the present invention.

What is claimed is:

1. A method of translating content executed by at least one server, comprising:
receiving an image file of a translation target in relation to an episode of content created based on a language of a first country;
extracting a text corresponding to the language of the first country from the image file; and
providing a translation editor for the image file so that a translated episode of the episode is generated based on a language of a second country different from the first country using the image file,
wherein the image file of the translation target is output in a first area of the translation editor, and an input window for inputting a translated language of the language of the second country for the extracted text is activated in a second area of the translation editor, and
the translated episode is generated using the translated language received through the input window.

2. The method of claim 1, further comprising:
converting the extracted text from the image file into a text corresponding to the translated language and displaying the converted text in the first area, in response to an input of the translated language into the input window.

3. The method of claim 2, wherein a movement guide for receiving a control command for a position movement of a text corresponding to the translated language is output in the first area so as to enable the position movement of the text corresponding to the translated language.

4. The method of claim 1, wherein a translation support tool for recommending the translated language based on a database of the languages of the first country and the second country is output in a third area of the translation editor.

5. The method of claim 4, wherein the first area, the second area, and the third area of the translation editor are sequentially arranged along one direction such that the image file and the translation support tool are output on both sides based on the input window.

6. The method of claim 4, wherein in response to an input for selecting one of the extracted text from the image file output in the first area is received, a list for recommending a translated language for the one of the extracted text is output in the third area.

7. The method of claim 6, wherein in response to a translated language being selected from the list, the translated language is input into the input window in response to the selection.

8. The method of claim 1, wherein a selection icon for selecting whether to translate at least one of the extracted text is output in the second area, and the input window for inputting a translated language in the language of the second country for at least one of the extracted text is deactivated responsive to an input to the selection icon.

9. The method of claim 8, wherein in response to the input window being deactivated, a speech bubble corresponding to at least one of the extracted text is output in an empty state in the first area.

10. The method of claim 1, further comprising:
providing a review editor for reviewing the extracted text and the translated language to enable a reviewer to perform a review of the translated language.

11. The method of claim 10, wherein in a first area of the review editor, the extracted text is converted into the translated language, and an image output in the first area of the translation editor is output, and an input window output in the second area of the translation editor is output in a second area of the review editor.

12. The method of claim 10, further comprising:
outputting a comparison window to the review editor,
wherein an image output in the first area of the translation editor and the image file of the translation target are both output in the comparison window.

13. The method of claim 1, wherein the translated episode is output in the first area and the image file of the translation target is output in the second area so as to enable a review of the translated episode.

14. A system for translating content, comprising:
a management server configured to register an image file of a translation target for an episode of content created based on a language of a first country; and
a translation server configured to receive the image file of the translation target,
wherein the translation server extracts a text corresponding to the language of the first country from the image file of the translation target, and provides a translation editor for the image file so that a translated episode of the episode is generated using the extracted text,
the image file of the translation target is output in a first area of the translation editor and an input window for inputting a translated language of a language of a second country for the extracted text is activated in a second area of the translation editor, and
the translated episode is generated using the translated language received through the input window.

15. The system of claim 14, wherein the extracted text is converted from the image file into a text corresponding to the translated language and displayed in the first area, in response to an input of the translated language into the input window.

16. A non-transitory computer-readable recording medium storing a program that enables at least one server to execute the steps comprising:
receiving an image file of a translation target in relation to an episode of content created based on a language of a first country;
extracting a text corresponding to the language of the first country from the image file; and
providing a translation editor for the image file so that a translated episode of the episode is generated based on a language of a second country different from the first country using the image file,
wherein the image file of the translation target is output in a first area of the translation editor and an input window for inputting a translated language of the language of the second country for the extracted text is activated in a second area of the translation editor, and
the translated episode is generated using the translated language received through the input window.
